(19) United States
(12) Patent Application Publication
(10) Pub. No.: US 2019/0056293 A1
(43) Pub. Date: Feb. 21, 2019

(54) METHOD OF SAMPLING PRESSURISED LIQUID

(71) Applicant: MP FILTRI UK LIMITED, Cheltenham (GB)

(72) Inventors: Frédéric LAGORS, Serpaize (FR); Andrew Christopher MUSTOE, Moreton in Marsh (GB)

(21) Appl. No.: 16/075,834

(22) PCT Filed: Feb. 6, 2016
(86) PCT No.: PCT/IB2016/050623

§ 371 Date: Aug. 6, 2018

(30) Foreign Application Priority Data
Feb. 6, 2015 (GB) 1502043.1

(51) Int. Cl. G01N 1/20; G01N 15/06

(52) U.S. Cl. CPC G01N 1/2035; G01N 2001/2057; G01N 15/06

(57) ABSTRACT

A method of determining particulate content in a hydraulic fluid contained in a hydraulic circuit the circuit having a standard hydraulic sampling output for sample collection comprising the steps of: connecting the sampling output to an adapter having a body unit with an internal press risible volume, an input and an output to the volume, and valve means whereby the input and output are either linked to one another or isolated from one another; the connection to the sampling output being by way of the adapter inlet; connecting the output of the adapter to a particle counter to provide an operable sampling combination; operating the valve means to provide for the input and the output of the adapter to be coupled to allow the controlled flow of pressurised hydraulic fluid from the sampling output to the counter so as to provide a sample of the fluid for analysis by the counter.

This invention relates to a method of sampling pressurised liquid.

### BACKGROUND

A vehicle, such as an aircraft, in operation makes use of at least one hydraulic system. To provide for safe operation of the vehicle there are legal requirements to be met in respect of such systems. There are international standards governing particulate contamination of the hydraulic fluid in use. Typically these require the sampling and testing of liquid used in the systems to establish that quality control levels are being met.

Passenger carrying aircraft make use of hydraulic systems and each system needs to be maintained at a certain cleanliness level. Such systems operate at relatively high pressure levels and at present to take a sample of a working liquid it is necessary to de-pressurise the system at least in the vicinity of a sampling outlet from the system. A sample of liquid is then withdrawn by way of the outlet and sent to a test station. A suitable test station is not necessarily available near the sampling point and following the extraction of the sample a lengthy wait can occur before the test result is available and further sampling and testing may be required. Delaying the availability of a commercial aircraft for this purpose is inconvenient.

### STATEMENT OF INVENTION

A method of determining particulate content in a hydraulic fluid contained in a hydraulic circuit the circuit having a standard hydraulic sampling output for sample collection comprising the steps of:
connecting the sampling output to an adapter having a body unit with an internal pressurisible volume, an input and an output to the volume, and valve means whereby the input and output are either linked to one another or isolated from one another; the connection to the sampling output being by way of the adapter inlet;
connecting the output of the adapter to a particle counter to provide an operable sampling combination;
operating the valve means to provide for the input and the output of the adapter to be coupled to allow the controlled flow of pressurised hydraulic fluid from the aircraft sampling output to the counter so as to provide a sample of the fluid for analysis by the counter.

An exemplary embodiment of the invention will now be described with reference to the accompanying drawings of which:

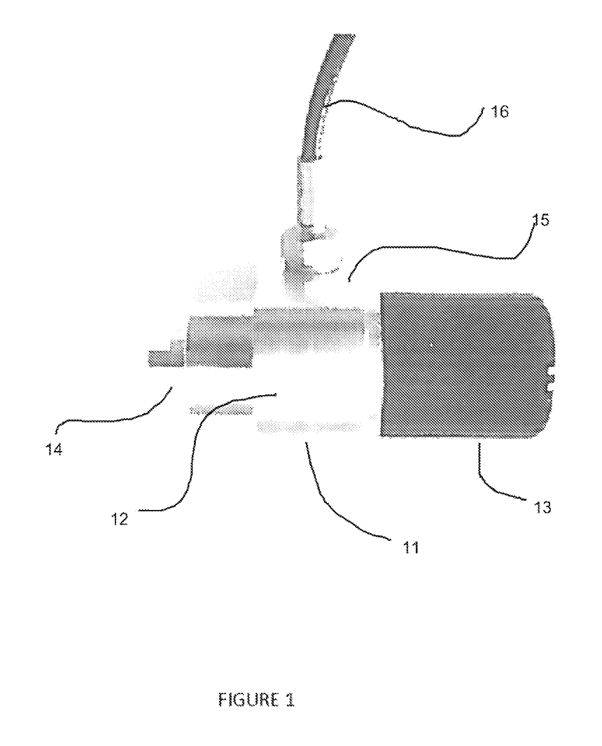

FIG. 1 shows an external view of a demountable adapter valve appropriate for use in the present method;

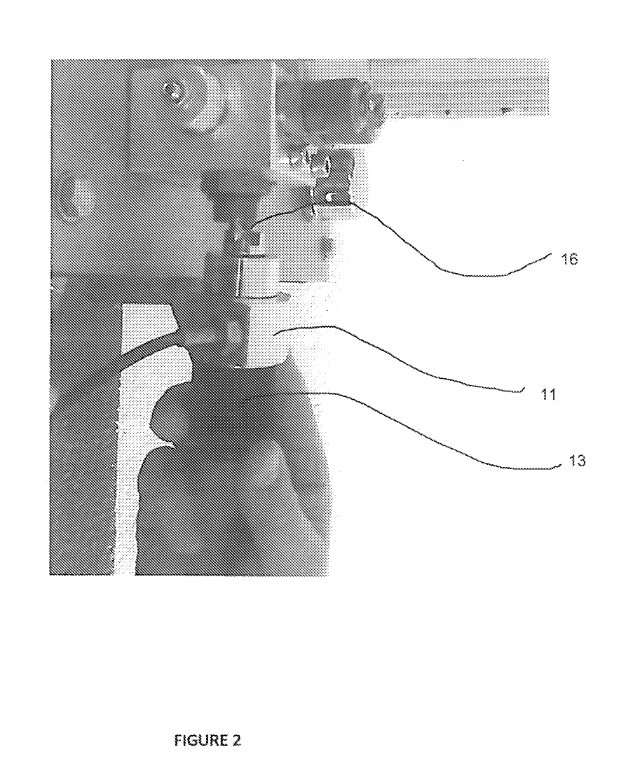

FIG. 2 shows the valve of FIG. 1 in prior to attachment to a sampling output of a hydraulic system;

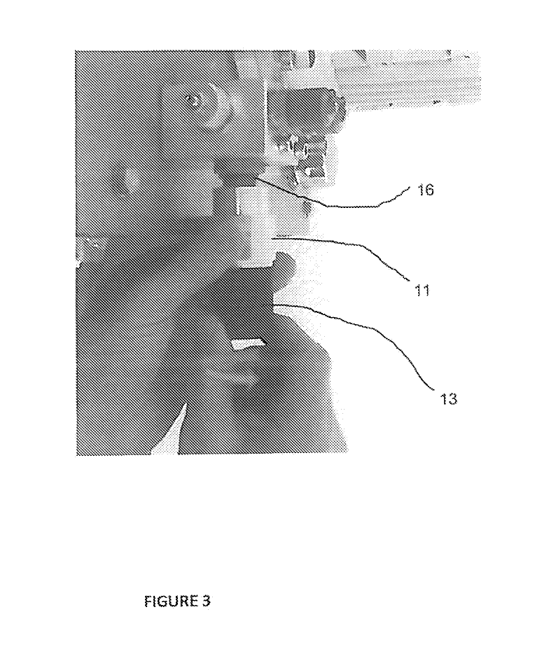

FIG. 3 shows the adapter valve of FIG. 1 following attachment to the sampling output;

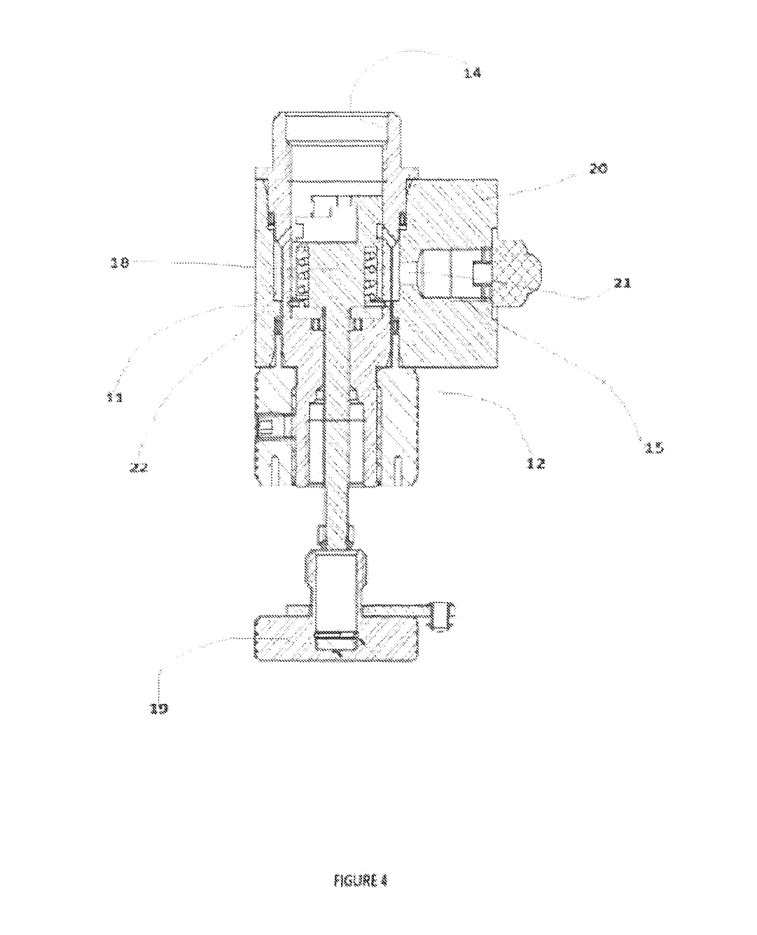

FIGS. 4 to 7 show the various configurations of the internal components of the adapter valve of FIG. 1 available for the purposes of the method of the present invention in which;

FIG. 4 shows the internal components once the adapter secured to the aircraft sampling output;

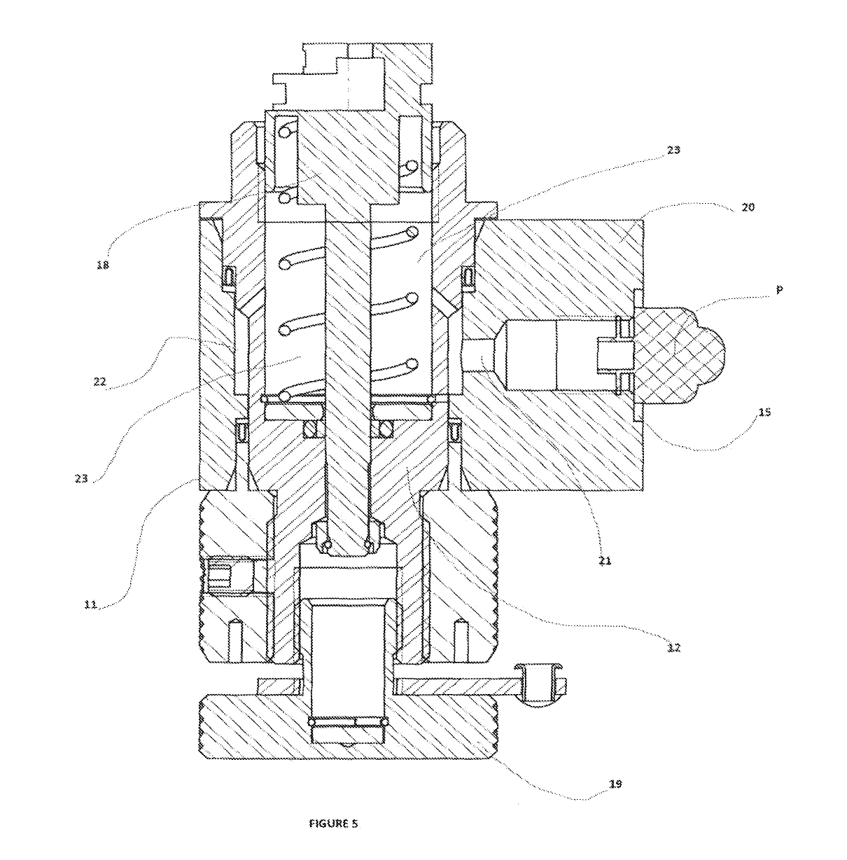

FIG. 5 shows the internal components of the adapter secured to the sampling output with the adapter linking the sampling output from a particle counter to provide for sample analysis.

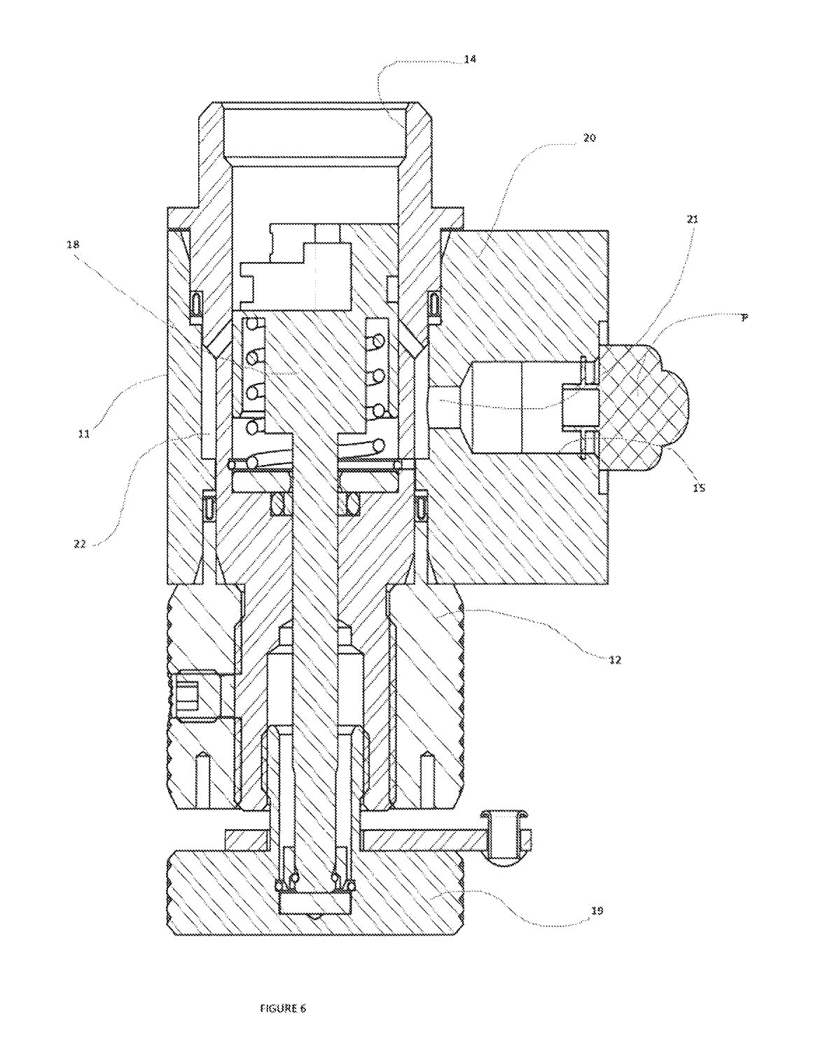

FIG. 6 shows the internal components of the adapter secured to the sampling output with the adapter isolating the sampling output from a particle counter; and

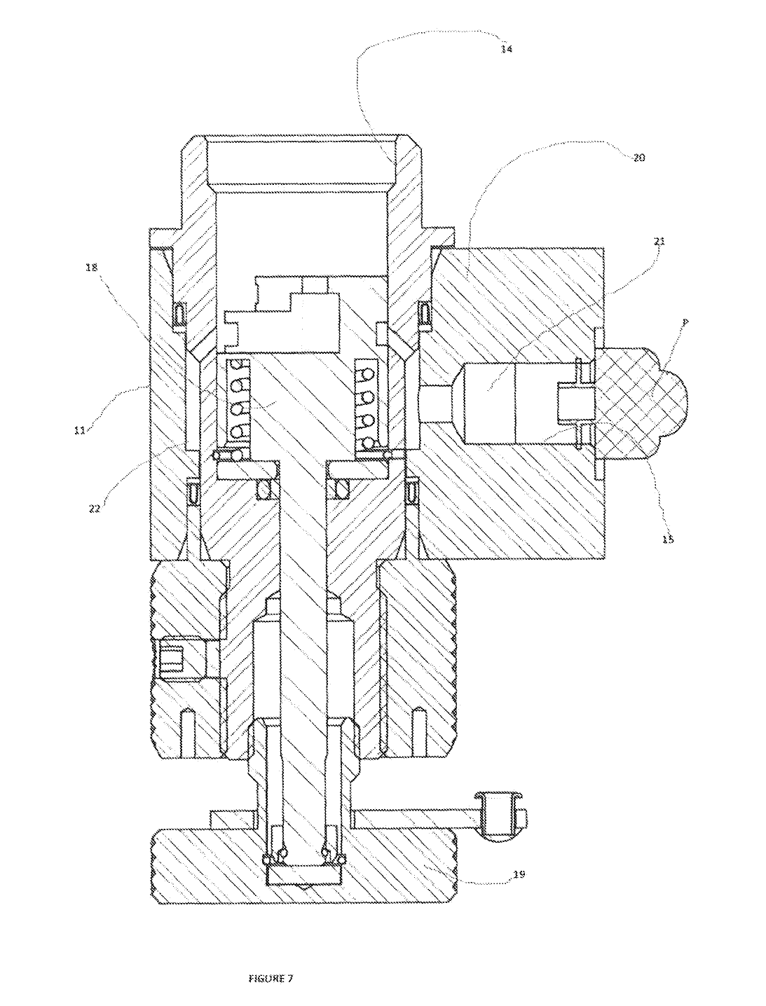

FIG. 7 shows the internal components of the adapter valve prior to attachment to an aircraft sampling output;

FIGS. 1 to 3 variously show external views of adapter 11 with a body member 12, rotary cap 13, inlet 14 and outlet 15 shown connected to a hose 16 whereby the adapter 11 is connected to a particle counter (not shown).

FIG. 2 shows the adapter 11 being offered up to an aircraft sampling output 16. Once the inlet 14 is initially engaged with output 16 the cap 13 is rotated relative to the body member 12 to provide for pressure tight engagement between adapter 11 and output 16 as shown ion FIG. 3.

FIGS. 4 to 7 are internal views of the adapter 11 in various working configurations.

FIG. 4 shows adapter 11 with input 14 ready for attachment to the aircraft sampling output. Body member 12 serves to house piston 18 which can be displace axially relative to the body member 12 by disc 19 over which cap 13 is usually located.

Adapter output 15 is provided on block 20 of adapter 11 through which block extends channel 21. The channel 21 is normally closed against ingress of foreign matter from outside by means of a plug P when not connected to a particle counter (not shown). The channel 21 opens into an annulus 22 on the body member 12 which is linked to internal volume 23 of the body member 12. The piston 18 serves either to isolate the channel 21 from the internal volume V of the body member as shown in FIG. 6 or to enable communication between internal volume V and the channel 21 and so the particle counter (as shown in FIG. 7) by way of annulus 24 in piston 18.

The adapter 11 is particularly intended for combination with the MP Filtri LPA2 Particle Counter product. This combination provides for measuring particulate contamination in conformity with a number of International Standards including IS04406, NAS1638, AS4059 Tables 1+2. In practice it has been found that the test procedure of the presently proposed method enables results to be obtained in about 15 minutes.

To use the adapter/particle counter combination the adapter is connected to an outlet sampler valve on the aircraft hydraulic system to be monitored as described heretofore in connection with FIGS. 1 to 7. Once connected the adapter is operated to provide for the controlled passage of a sample of hydraulic fluid to the coupled particle counter whereupon a predetermined test sequence is carried out to establish the particulate content. If required the results of the first sample can be dispensed with and one or more further samples can be taken to meet required test criteria.

1. A method of determining particulate content in a hydraulic fluid contained in a hydraulic circuit the circuit having a standard hydraulic sampling output for sample collection comprising the steps of:
connecting the sampling output to an adapter having a body unit with an internal press risible volume, an input and an output to the volume, and valve means whereby the input and output are either linked to one another or isolated from one another; the connection to the sampling output being by way of the adapter inlet;
connecting the output of the adapter to a particle counter to provide an operable sampling combination;
operating the valve means to provide for the input and the output of the adapter to be coupled to allow the controlled flow of pressurised hydraulic fluid from the sampling output to the counter so as to provide a sample of the fluid for analysis by the counter.

2. A method of determining sampling particulate content in a hydraulic fluid contained in a hydraulic circuit as hereinbefore described with reference to the accompanying drawings.
